(19) United States
(12) Patent Application Publication
(10) Pub. No.: US 2024/0244405 A1
(43) Pub. Date: Jul. 18, 2024

(54) SENSOR TERMINAL, DATA COLLECTION UNIT, DATA COLLECTION SYSTEM, DATA COLLECTION METHOD, AND PROGRAM

(71) Applicant: NIPPON TELEGRAPH AND TELEPHONE CORPORATION, Tokyo (JP)

(72) Inventors: Shinya TAMAKI, Musashino-shi, Tokyo (JP); Ryota SHIINA, Musashino-shi, Tokyo (JP); Tetsuya SUZUKI, Musashino-shi, Tokyo (JP); Yasutaka KIMURA, Musashino-shi, Tokyo (JP); Tomohiro TANIGUCHI, Musashino-shi, Tokyo (JP)

(73) Assignee: NIPPON TELEGRAPH AND TELEPHONE CORPORATION, Tokyo (JP)

(21) Appl. No.: 18/579,791

(22) PCT Filed: Aug. 2, 2021
(86) PCT No.: PCT/JP2021/028634

§ 371 Date: Jan. 16, 2024

(51) Int. Cl. H04W 4/38; G06F 16/908; H04W 4/029

(52) U.S. Cl. CPC H04W 4/38; G06F 16/908; H04W 4/029

(57) ABSTRACT

An object of the present invention is to provide a sensor terminal, a data collection unit, a data collection system, a data collection method, and a program capable of handling highly real-time sensing data while eliminating the need to generate a highly reliable timestamp. In a data collection system 302, a sensor terminal 11 receives broadcast time information (step S01), the sensor terminal 11 transmits related time information related to the time information and sensing data as a set (step S02), a data collection unit 12 receives the set (step S03), and the data collection unit 12 organizes the related time information and the sensing data included in the set in a database 12d on the basis of information for identifying the sensor terminal 11 (step S04).

### TECHNICAL FIELD

The present disclosure relates to collection of sensing data in the Internet of things (IoT).

### BACKGROUND ART

Non Patent Literature 1 discloses a technique of collecting data obtained from things and data of positions and a flow of people in real time in a specific indoor space such as a factory or a commercial facility.

### CITATION LIST

### Non Patent Literature

Non Patent Literature 1: Digital Transformation Channel, “Okunai ichi sokui gijutsu, dore ga ii? (Which indoor positioning technology is better?)” https://www.digital-transformation-real.com/blog/which-indoor-positioning-technology-is-better (May 28, 2020)

### SUMMARY OF INVENTION

### Technical Problem

In order to specify a position of a mobile terminal by using the technology disclosed in Non Patent Literature 1, processing with real-time sensing data such as acceleration is required. In order to perform the processing with real-time sensing data, it is necessary to generate a highly reliable timestamp in the mobile terminal. However, it is difficult for an inexpensive terminal or a battery-driven terminal to generate a highly reliable timestamp. That is, it is difficult for an inexpensive terminal or a battery-driven terminal to handle highly real-time sensing data, which is problematic.

In order to solve the above problems, an object of the present invention is to provide a sensor terminal, a data collection unit, a data collection system, a data collection method, and a program capable of handling highly real-time sensing data while eliminating the need to generate a highly reliable timestamp.

### Solution to Problem

In order to achieve the above object, a sensor terminal according to the present invention uses a timestamp broadcast from the outside to handle highly real-time sensing data.

Specifically, the sensor terminal according to the present invention includes: a time receiving unit that receives broadcast time information; and an operation unit that transmits related time information related to the time information and sensing data as a set to a data collection unit. Because the sensor terminal uses a timestamp (time information) broadcast from the outside, the sensor terminal is not required to generate a highly reliable timestamp. Therefore, the present invention can provide a sensor terminal capable of handling highly real-time sensing data while eliminating the need to generate a highly reliable timestamp.

The related time information may be the broadcast timestamp. However, the related time information may be the time information and a time required for transmission processing or may be information obtained by adding the time required for the transmission processing to the time information.

The operation unit preferably includes, in the set, information regarding a location metadata source received in an arbitrary area. This makes it possible to grasp an absolute position of the sensor terminal.

A data processing unit according to the present invention includes: an information receiving unit that receives the set transmitted from the sensor terminal; and a data processing unit that organizes the related time information and the sensing data included in the set in a database on the basis of information for identifying the sensor terminal.

That is, a data collection system according to the present invention includes: the sensor terminal; and the data collection unit, and a method thereof includes: the sensor terminal receiving broadcast time information; the sensor terminal transmitting related time information related to the time information and sensing data as a set; the data collection unit receiving the set; and the data collection unit organizing the related time information and the sensing data included in the set in a database on the basis of information for identifying the sensor terminal.

The present invention is a program for causing a computer to function as the sensor terminal or the data collection unit. The sensor terminal and the data processing unit of the present invention can also be implemented by a computer and a program, and the program can be recorded in a recording medium or be provided via a network.

Note that the inventions described above can be combined in any possible manner.

### Advantageous Effects of Invention

The present invention can provide a sensor terminal, a data collection unit, a data collection system, a data collection method, and a program capable of handling highly real-time sensing data while eliminating the need to generate a highly reliable timestamp.

### BRIEF DESCRIPTION OF DRAWINGS

FIG. 1 illustrates a data collection system according to the present invention.

FIG. 2 illustrates a sensor terminal included in the data collection system according to the present invention.

FIG. 3 illustrates a data collection unit included in the data collection system according to the present invention.

FIG. 4 illustrates an example where the data collection system according to the present invention stores sensor data and metadata in a frame.

FIG. 5 illustrates an example where the data collection system according to the present invention stores sensor data and metadata in a frame.

FIG. 6 illustrates the data collection system according to the present invention.

FIG. 7 illustrates a time information transmission unit included in the data collection system according to the present invention.

FIG. 8 illustrates the sensor terminal included in the data collection system according to the present invention.

FIG. 9 illustrates the data collection unit included in the data collection system according to the present invention.

FIG. 10 illustrates an operation of the data collection system according to the present invention.

FIG. 11 illustrates an operation of the sensor terminal according to the present invention.

FIG. 12 illustrates an operation of the data collection unit according to the present invention.

FIG. 13 illustrates the data collection system according to the present invention.

FIG. 14 illustrates the sensor terminal or data collection unit according to the present invention.

### DESCRIPTION OF EMBODIMENTS

Embodiments of the present invention will be described with reference to the accompanying drawings. The embodiments described below are an examples of the present invention, and the present invention is not limited to the following embodiments. Note that components having the same reference signs in the present specification and the drawings denote the same components.

### First Embodiment

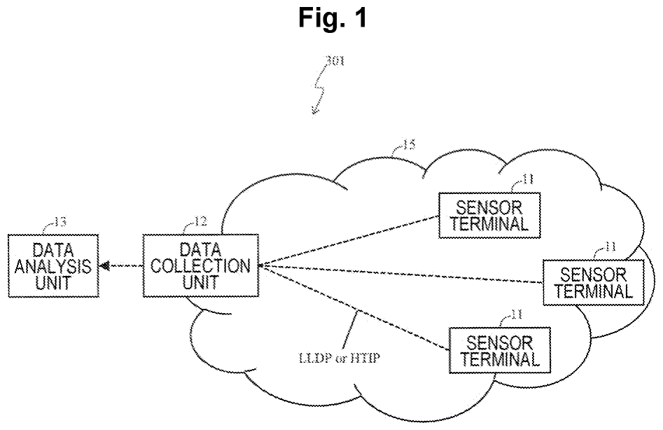

FIG. 1 illustrates a data collection system 301 of the present embodiment. The data collection system 301 is a data collection system that performs communication from terminals 11 to a data collection unit 12 by using a standardized communication protocol (LLDP or HTIP), in which the terminal 11 stores sensing data detected by a sensor device in an extension area different from an area for storing metadata in a frame defined by the communication protocol, and
the data collection unit 12 associates the sensing data with the metadata on the basis of information for identifying the terminal described in the frame.

A data collection network 15 is a network that connects the sensor terminals 11 and the data collection unit 12 existing in a specific range. The data collection network 15 is, for example, a local area network (LAN), a field area network (FAN), or an IoT area network.

The sensor terminal 11 performs sensing regarding an object to be observed and generates sensing data. In the same data collection network 15, there may be a plurality of sensor terminals 11 of a single type, or there may be a plurality of sensor terminals of a plurality of types. The sensor terminal 11 uses, for example, a lightweight and standardized communication protocol such as LLDP or HTIP and collectively transmits the sensing data and various kinds of metadata, such as device information including a product name, a model number, and the like and network configuration information, to the data collection unit 12. Details of the sensor terminal 11 will be described later.

The data collection unit 12 is, for example, an IoT gateway, an access point, or other various housing devices. The data collection unit 12 passes the collected sensing data and metadata as information associated with the sensor terminal 11 to a data analysis unit 13. Details of the data collection unit 12 will also be described later.

The data analysis unit 13 stores the information passed from the data collection unit 12 and uses the information for analysis. The data analysis unit 13 may be provided in the same device as the data collection unit 12 or in another device. In a case where the data analysis unit is provided in another device, the data analysis unit may be located away from the data collection unit 12 via a network.

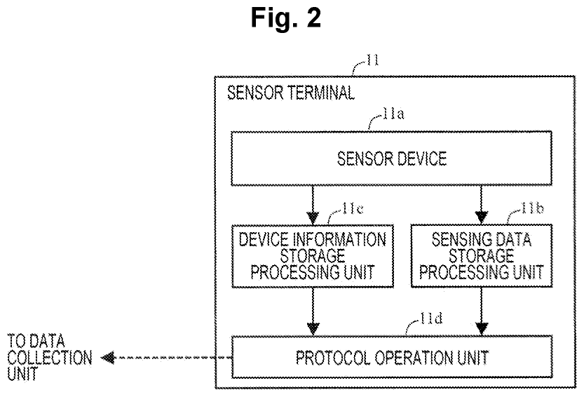

FIG. 2 illustrates the sensor terminal 11. The sensor terminal 11 includes a sensor device 11a, a device information storage processing unit 11c, a sensing data storage processing unit 11b, and a protocol operation unit 11d. The sensor device 11a performs sensing regarding an object to be observed. The device information storage processing unit 11c collects the device information (e.g. a manufacturer name, model name, and model number of the device) of the object to be observed and stores the information in a predetermined position of a frame. The sensing data storage processing unit 11b stores sensing data from the sensor device 11a in a specific extension area of the frame. The protocol operation unit 11d transmits the frame in which the sensing data is stored in the specific extension area to the data collection unit 12. Examples of the communication protocol include LLDP and HTIP (JJ-300.00).

The sensing data storage processing unit 11b may process the sensing data so as to conform to the form or restriction of the specific extension area of the frame and then store the sensing data in the frame. For example, the sensing data storage processing unit 11b may convert the sensing data into a certain shortened code and store the converted sensing data or may divide (fragment) the sensing data into a plurality of frames and store the divided sensing data.

The sensing data storage processing unit 11b can arbitrarily set a storage timing at which the sensing data is stored in the frame. For example, the storage timing may be set such that the sensing data is stored every time when the sensing data is updated, or the sensing data may be stored not sequentially but at a timing at which the sensing data is accumulated for a certain period of time.

In a case where the sensing data is accumulated for a certain period of time, the sensing data storage processing unit 11b may store a record (log) thereof or a result of specific calculation/statistical processing in the frame.

The type and storage timing of the sensing data to be stored in the frame may be fixed or vary. The type and storage timing of the sensing data may be dynamically changed in response to determination by the sensor terminal 11 itself or an instruction from the data analysis unit 13 or the data collection unit 12.

A transmission cycle of the frame may also be fixed or vary. The transmission cycle of the frame may be dynamically changed in response to determination by the sensor terminal 11 itself or an instruction from the data analysis unit 13 or the data collection unit 12.

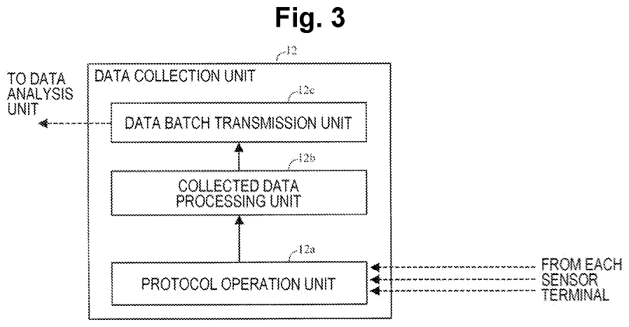

FIG. 3 illustrates the data collection unit 12. The data collection unit 12 includes a protocol operation unit 12a, a collected data processing unit 12b, and a data batch transmission unit 12c. The protocol operation unit 12a receives the frame in which the sensing data is stored in the specific extension area from the sensor terminal 11.

Examples of the communication protocol include LLDP and HTIP (JJ-300.00). The collected data processing unit 12b extracts the sensing data and various kinds of metadata from the received frame and organizes the data in a database on the basis of information for identifying the individual sensor terminal 11 (e.g. MAC address). The data batch transmission unit 12c stores the data organized in the database in a payload portion of the frame at a predetermined timing and transmits the frame to the data analysis unit 13. The data batch transmission unit 12c may transmit only part of the data or all the data in the database depending on a requirement of the data analysis unit 13.

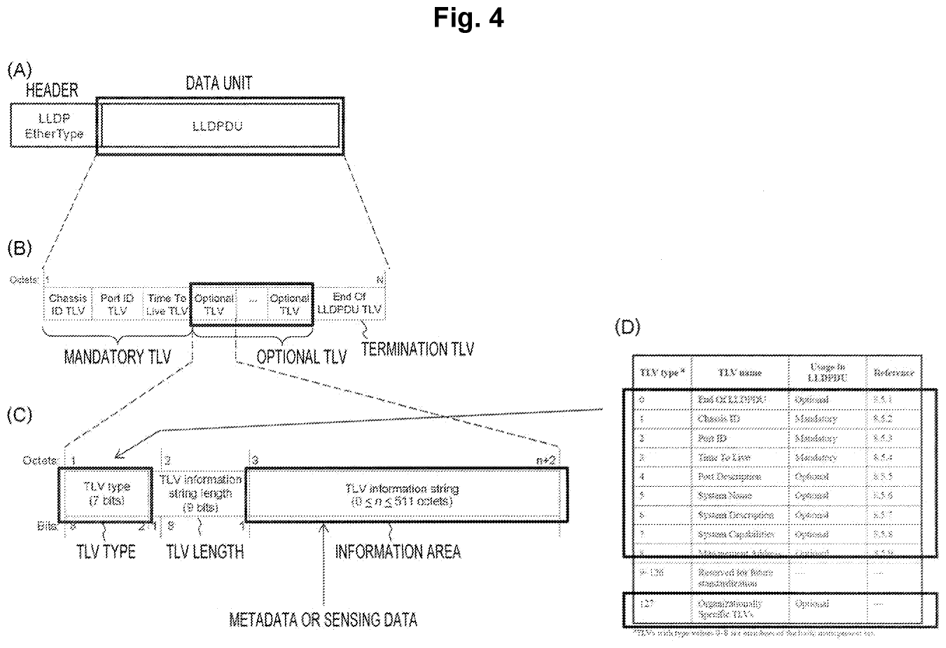

FIG. 4 illustrates an example where the sensor data and the metadata are stored in the frame in a case where the data collection system 301 adopts the LLDP (see, for example, Non Patent Literature 3) as the communication protocol. FIG. 4(A) illustrates a frame configuration of the LLDP. A frame of the LLDP includes a header and a data unit. FIG. 4(B) illustrates a format of the data unit. The data unit includes a mandatory TLV, an optional TLV, and a termination TLV. FIG. 4(C) illustrates a format of one optional TLV. The optional TLV includes a TLV type, a TLV length, and an information area. FIG. 4(D) is a list of types of the optional TLV. When “1” to “8” are input as the TLV type, various kinds of information, such as a device name, a manufacturer name, a MAC address, or an IP address, can be stored as the metadata in the information area of the optional TLV. When “127” is input as the TLV type, the information area of the optional TLV serves as the extension area and thus can store the sensing data.

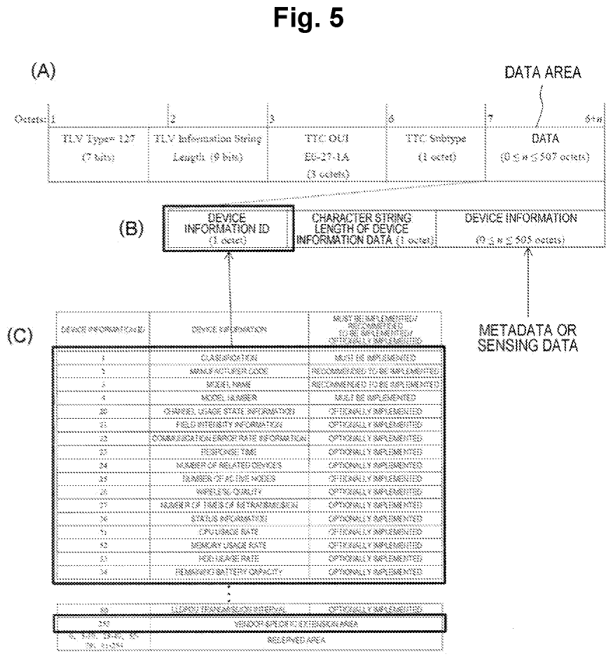

FIG. 5 illustrates an example where the sensor data and the metadata are stored in the frame in a case where the data collection system 301 adopts the HTIP (see, for example, Non Patent Literature 4) as the communication protocol. FIG. 5(A) illustrates a frame configuration of the HTIP. A frame of the HTIP includes an area for describing the TLV type and length and a data area. FIG. 5(B) illustrates a format of the data area. The data area includes a device information ID, a device information data length, and device information. FIG. 5(C) is a list of the device information IDs. When “1” to “4”, “20” to “27”, and “50” to “54” are input as the device information ID, various kinds of information, such as a device name, a manufacturer name, a MAC address, or an IP address, can be stored as the metadata in a device information area of the data area. When “255” is input as the device information ID, the device information area of the data area serves as a vendor-specific extension area and thus can store the sensing data.

### Second Embodiment

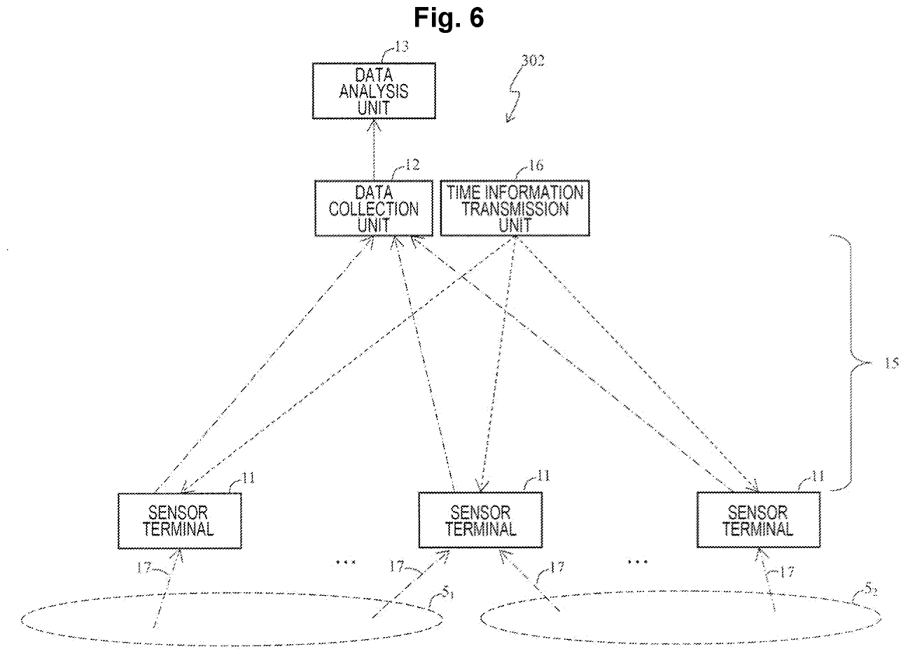

FIG. 6 illustrates a data collection system 302 of the present embodiment. The data collection system 302 is such that a time information transmission unit 16 is added to the data collection system 301 of FIG. 1. The time information transmission unit 16 broadcasts a timestamp (time information). The data collection unit 12 and the time information transmission unit 16 may be integrated or may be separate devices.

The sensor terminal 11 can measure not only the sensing data described in the first embodiment but also highly real-time data such as acceleration data, store the data in a frame, and transmit the frame. The communication protocol is a low layer communication protocol such as the LLDP or HTIP described above. The “low layer communication protocol” means a protocol corresponding to a second layer or third layer of the OSI reference model.

Further, the sensor terminal 11 can receive information 17 from a location metadata source in an area 5 where the sensor terminal exists, also store the information in the frame, and transmit the frame. The location metadata source is a BLE beacon signal, a visible light pattern, sound, or other kinds of information and may be any information as long as the information can be interpreted by the data analysis unit 13.

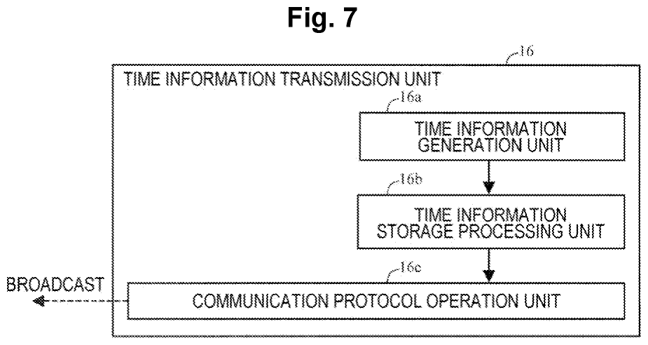

FIG. 7 illustrates the time information transmission unit 16. The time information transmission unit 16 may be integrated with an access point or a gateway device. The time information transmission unit 16 includes a time information generation unit 16a, a time information storage processing unit 16b, and a communication protocol operation unit 16c. The time information generation unit 16a generates a highly reliable timestamp. The time information storage processing unit 16b stores the timestamp generated by the time information generation unit 16a in an optional area in the frame of the communication protocol. The optional area is, for example, a vendor specific area of a probe request or probe response frame in Wi-Fi communication or is an extension area of the LLDP in Ethernet (registered trademark) communication. The communication protocol operation unit 16c broadcasts the frame.

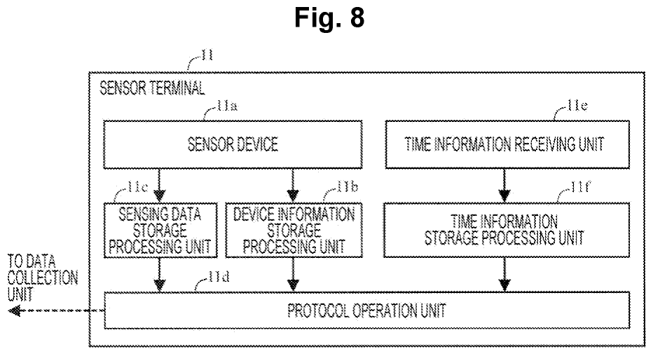

FIG. 8 illustrates the sensor terminal 11 of the present embodiment. The sensor terminal 11 further includes a time information receiving unit 11e and a time information storage processing unit 11f in addition to the English Translation of sensor terminal 11 described in FIG. 2. The time information receiving unit 11e receives the frame including the time information (timestamp) broadcast from the time information transmission unit 16. The time information storage processing unit 11f stores a set of related time information related to the time information and the sensing data in the specific extension area of the frame described above together with the sensing data storage processing unit 11b. The protocol operation unit 11d transmits the frame in which the device information is stored in a predetermined area and the set is stored in the specific extension area to the data collection unit 12.

The time information storage processing unit 11f may directly use the time information received from the time information transmission unit 16 as a timestamp (related time information). The time information storage processing unit 11f can also use a set of the time information received from the time information transmission unit 16 and a time taken for processing in the sensor terminal 11 as the related time information. The time information storage processing unit 11f can also use a time obtained by adding the time taken for processing in the sensor terminal 11 to the time information received from the time information transmission unit 16 as the related time information.

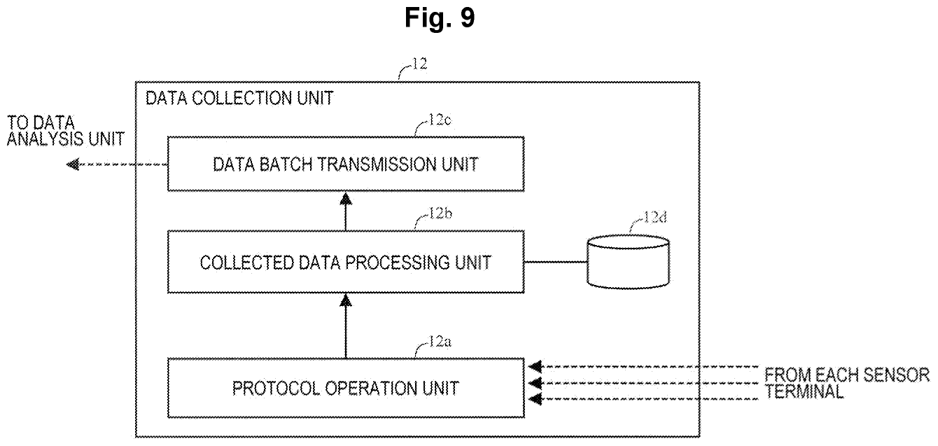

FIG. 9 illustrates the data collection unit 12 of the present embodiment. The data collection unit 12 is such that a database 12d in which the collected data processing unit 12b organizes the related time information and the sensing data included in the set on the basis of the information for identifying the sensor terminal 11 is added to the data collection unit 12 described in FIG. 3.

The collected data processing unit 12b organizes the sensing data and the time information from each sensor terminal 11 in the database 12d on the basis of the information for identifying the individual sensor terminal 11. Specifically, the collected data processing unit associates the related time information, the sensing data, and the various kinds of metadata with each other on the basis of the device identification such as the MAC address of the sensor terminal 11.

The collected data processing unit 12b extracts the related time information, the sensing data, and the various kinds of metadata from the database 12d at a predetermined timing and stores the extracted information and data in a payload portion of the frame to be transmitted by the data batch transmission unit 12c. At this time, only part of the data or all the data may be transmitted depending on a requirement of the data analysis unit 13.

In a case where the data analysis unit 13 needs to grasp time with higher accuracy, the data analysis unit 13 may add the received timestamp and a timestamp of the current time side by side. The data analysis unit 13 can perform analysis in consideration of a time taken for communication and calculation processing in the terminal.

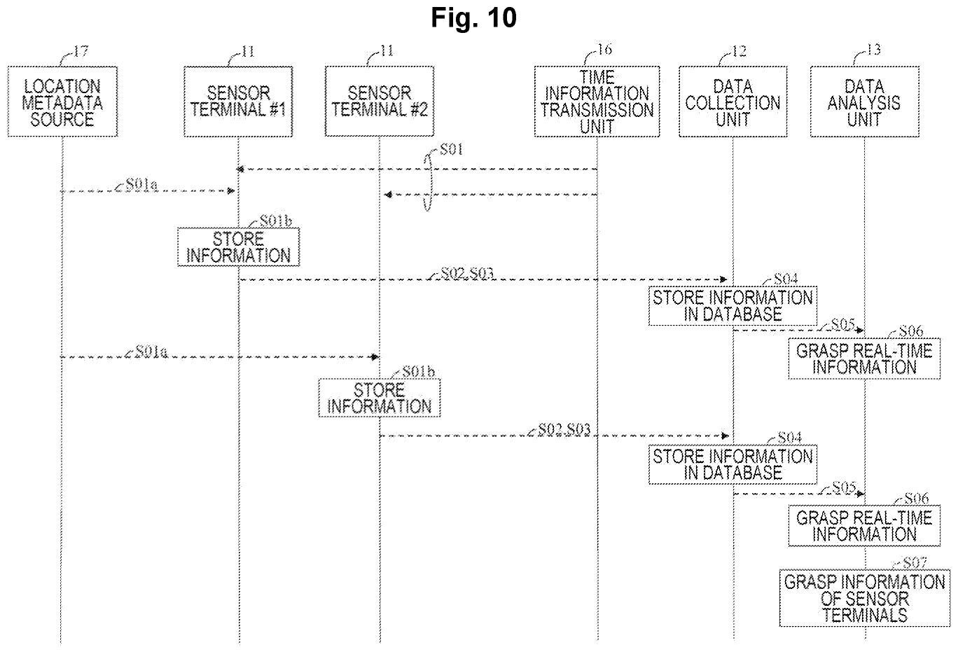

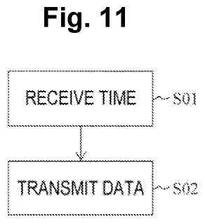

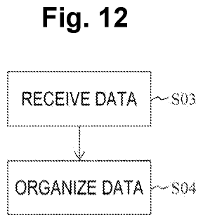

FIG. 10 illustrates an operation of the data collection system 302. FIGS. 11 and 12 illustrate operations of the sensor terminal 11 and the data collection unit 12, respectively. In the data collection system 302, the sensor terminal 11 receives broadcast time information (step S01), the sensor terminal 11 transmits related time information related to the time information and sensing data as a set (step S02), the data collection unit 12 receives the set (step S03), and the data collection unit 12 organizes the related time information and the sensing data included in the set in the database 12d on the basis of information for identifying the sensor terminal 11 (step S04).

Although the number of the sensor terminals 11 is two in FIG. 10, the number of the sensor terminals 11 is not limited to two. FIG. 10 illustrates a case where information is also obtained from the location metadata source in order to specify the position of the sensor terminal 11.

Description thereof will be made in more detail. The time information transmission unit 16 broadcasts highly reliable time information. Each sensor terminal 11 receives the time information (step S01).

Meanwhile, the sensor terminal 11 may acquire information regarding a position (location metadata information) from the location metadata source (e.g. BLE beacon) located in the area 5 where the sensor terminal exists (step S01a).

Each sensor terminal 11 stores the sensing data acquired by the sensor terminal itself, the location metadata information, and the related time information as a set in the extension area in the frame defined by the communication protocol (step S01b). Each sensor terminal 11 transmits the frame (step S02), and the data collection unit 12 receives the frame (step S03). At this time, the frame is transmitted and received by the low layer communication protocol with a low load and low delay.

The data collection unit 12 extracts the sensing data, the location metadata information, and the related time information from the received frame and organizes the information in the database 12d on the basis of the information for identifying the sensor terminal 11 (step S04). The data collection unit 12 also extracts the information from the database 12d at a predetermined timing and transmits the extracted information to the data analysis unit 13 (step S05). In a case where real-time property is emphasized, the predetermined timing may be shortened, and information included in the frame may be transmitted to the data analysis unit 13 immediately after the frame is received.

The data analysis unit 13 can obtain highly real-time information from the information (sensing data, location metadata information, and related time information) transmitted from the data collection unit 12 (step S06). For example, in a case where the sensing data is acceleration of the sensor terminal 11, the data analysis unit 13 can accurately grasp a current absolute position of the sensor terminal 11 in combination with the English Translation of location metadata information.

The data analysis unit 13 may generate comprehensive information on the basis of the highly real-time information acquired from each sensor terminal 11 (step S07). For example, in a case where the current absolute position is acquired from each sensor terminal 11, the data analysis unit 13 can grasp a relative position between the sensor terminals 11 (whether or not the sensor terminals are close to each other).

### Third Embodiment

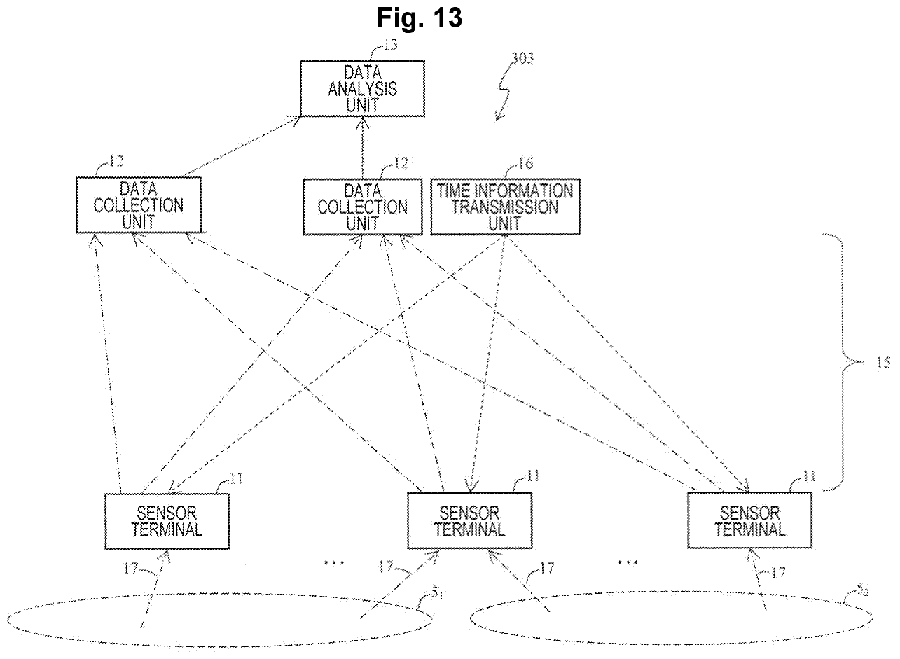

FIG. 13 illustrates a data collection system 303 of the present embodiment. The data collection system 303 is different from the data collection system 302 of FIG. 6 in that the data collection system 303 includes a plurality of data collection units 12. That is, the data collection system 303 includes the plurality of data collection units 12, and the terminal 11 transmits a frame having the same content to each of the data collection units 12.

An operation of the sensor terminal 11 is the same as the operation described in the first embodiment. However, when transmitting a frame, the sensor terminal 11 broadcasts the frame to the plurality of data collection units 12 in the data collection network 15 by a broadcast operation of the LLDP or HTIP.

Operations of each sensor terminal 11, each data collection unit 12, and the time information transmission unit 16 are the same as the operations described in the second embodiment. The data analysis unit 13 can acquire related time information, sensing data, and location metadata organized for each sensor terminal 11 from the plurality of data collection units 12. The data analysis unit 13 may adopt data from any one of the data collection units 12 in a case where the data from the plurality of data collection units 12 is the same. Meanwhile, in a case where data from one data collection unit 12 is missing, data from another data collection unit 12 is adopted to avoid data missing.

That is, the data collection system 303 can improve system reliability by redundancy, as compared with the data collection system 302 of FIG. 6.

### Fourth Embodiment

The sensor terminal 11 and the data collection unit 12 can also be implemented by a computer and a program, and the program can be recorded in a recording medium or be provided via a network.

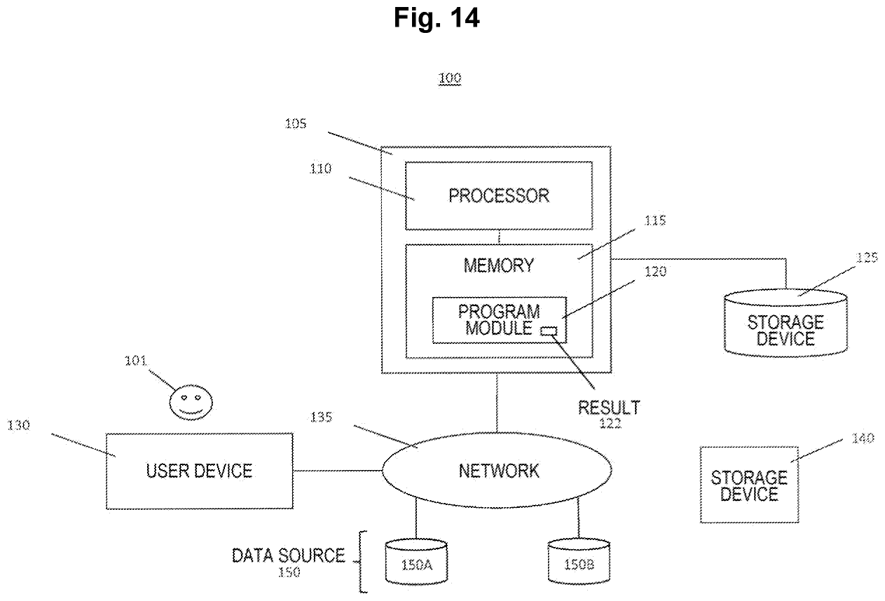

FIG. 14 illustrates a block diagram of a system 100. The system 100 includes a computer 105 connected to a network 135.

The network 135 is a data communication network. The network 135 may be a private network or a public network and may include any or all of (a) a personal area network covering, for example, a room, (b) a local area network covering, for example, a building, (c) a campus area network covering, for example, a campus, (d) a metropolitan area network covering, for example, a city, (e) a wide area network covering, for example, an area connected across boundaries of cities, rural areas, or countries, and (f) the Internet. Communication is performed by an electronic signal and an optical signal via the network 135.

The computer 105 includes a processor 110 and a memory 115 connected to the processor 110. In the present specification, the computer 105 is represented as a standalone device. However, the computer is not limited thereto and may be connected to other devices (not illustrated) in a distributed processing system.

The processor 110 is an electronic device including a logic circuitry that responds to a command and executes the command.

The memory 115 is a tangible computer-readable storage medium in which a computer program is encoded. Regarding this point, the memory 115 stores data and commands, that is, program codes, which are readable and executable by the processor 110 to control operation of the processor 110. The memory 115 can be implemented by a random access memory (RAM), a hard drive, a read-only memory (ROM), or a combination thereof. One of the components of the memory 115 is a program module 120.

The program module 120 includes commands for controlling the processor 110 to execute processes described in the present specification. In the present specification, operations are described as being performed by the computer 105 or a method, a process, or a sub-process thereof. However, the operations are actually executed by the processor 110.

In the present specification, the term “module” is used to refer to a functional operation that can be embodied either as a standalone component or as an integrated configuration of a plurality of sub-components. Thus, the program module 120 can be implemented as a single module or as a plurality of modules that operate in cooperation with each other. In the present specification, the program module 120 is described as being installed in the memory 115 and thus implemented in software. However, the program module can be implemented in any of hardware (e.g. electronic circuit), firmware, software, or a combination thereof.

Although the program module 120 is described as already being loaded into the memory 115, the program module 120 may be provided in a storage device 140 so as to be subsequently loaded into the memory 115. The storage device 140 is a tangible computer-readable storage medium that stores the program module 120. Examples of the storage device 140 include a compact disk, a magnetic tape, a read-only memory, an optical storage medium, a hard drive, a memory unit including a plurality of parallel hard drives, and a universal serial bus (USB) flash drive. Alternatively, the storage device 140 may be a random access memory or another type of electronic storage device located in a remote storage system (not illustrated) and connected to the computer 105 via the network 135.

The system 100 further includes a data source 150A and a data source 150B, which are collectively referred to as a data source 150 in the present specification and are communicatively connected to the network 135. In practice, the data source 150 can include an arbitrary number of data sources, that is, one or more data sources. The data source 150 can include unstructured data and can include social media.

The system 100 further includes a user device 130 operated by a user 101 and connected to the computer 105 via the network 135. Examples of the user device 130 include an input device, such as a keyboard or a voice recognition subsystem, for enabling the user 101 to input information and command selections to the processor 110.

The user device 130 further includes an output device such as a display device, a printer, or a speech synthesizer. A cursor control unit, such as a mouse, a trackball, or a touch-sensitive screen, allows the user 101 to operate a cursor on the display device to input further information and command selections to the processor 110.

The processor 110 outputs a result 122 of execution of the program module 120 to the user device 130. Alternatively, the processor 110 can supply the output to a storage device 125 such as a database or a memory or to a remote device (not illustrated) via the network 135.

For example, a program for performing processing in the flowchart of FIGS. 11 and 12 may be used as the program module 120. The system 100 can be operated as the sensor terminal 11 and the data collection unit 12, respectively.

The term “include . . . ” or “including . . . ” specifies that the mentioned features, integers, steps, or components are present, but should be understood as not excluding the presence of one or more other features, integers, steps, or components, or groups thereof. The terms “a” and “an” are indefinite articles and thus do not exclude embodiments including a plurality of objects.

### OTHER EMBODIMENTS

The present invention is not limited to the above embodiments, and various modifications can be made without departing from the gist of the present invention. In short, the present invention is not limited to the above embodiments, and the components may be modified and embodied in the implementation stage, without departing from the scope of the present invention.

Various inventions can be made by appropriately combining a plurality of components disclosed in the above embodiments. For example, some components may be removed from all the components described in the embodiments.

Further, components in different embodiments may be appropriately combined.

### REFERENCE SIGNS LIST

11 Sensor terminal
11a Sensor device
11b Device information storage processing unit
11c Sensing data storage processing unit
11d Protocol operation unit
11e Time information receiving unit
11f Time information storage processing unit
12 Data collection unit
12a Protocol operation unit
12b Collected data processing unit
12c Data batch transmission unit
12d Database
13 Data analysis unit
Data collection network
16 Time information transmission unit
16a Time information generation unit
16b Time information storage processing unit
16c Communication protocol operation unit
100 System
101 User
105 Computer
110 Processor
115 Memory
120 Program module
122 Result
125 Storage device
130 User device
135 Network
140 Storage device
150 Data source
301 to 303 Data collection system

1. A sensor terminal comprising:
a time receiving unit that receives broadcast time information; and
an operation unit that transmits related time information related to the time information and sensing data as a set to a data collection unit.

2. The sensor terminal according to claim 1, wherein
the related time information is the time information and a time required for transmission processing or information obtained by adding the time required for the transmission processing to the time information.

3. The sensor terminal according to claim 1, wherein
the operation unit includes, in the set, information of a location metadata source received in an arbitrary area.

4. A data collection unit comprising:
an information receiving unit that receives the set transmitted from the sensor terminal according to claim 1; and
a data processing unit that organizes the related time information and the sensing data included in the set in a database on the basis of information for identifying the sensor terminal.

5. (canceled)

6. A data collection method comprising:
a sensor terminal receiving broadcast time information;
the sensor terminal transmitting related time information related to the time information and sensing data as a set;
a data collection unit receiving the set; and
the data collection unit organizing the related time information and the sensing data included in the set in a database on the basis of information for identifying the sensor terminal.

7. A non-transitory computer-readable medium having computer-executable instructions that, upon execution of the instructions by a processor of a computer, cause the computer to function as the sensor terminal according to claim 1.

8. A non-transitory computer-readable medium having computer-executable instructions that, upon execution of the instructions by a processor of a computer, cause the computer to function as the data collection unit according to claim 4.
